(19) United States
(12) Patent Application Publication
(10) Pub. No.: US 2014/0004462 A1
(43) Pub. Date: Jan. 2, 2014

(54) MAKING ARTICLE WITH DESIRED PROFILE

(71) Applicant: MARK CAMERON ZARETSKY, Rochester, NY (US)

(72) Inventor: MARK CAMERON ZARETSKY, Rochester, NY (US)

(21) Appl. No.: 13/537,165

(22) Filed: Jun. 29, 2012

(51) Int. Cl. G03G 13/20

(52) U.S. Cl. 430/124.1

(57) ABSTRACT

A method of making an article such as a lens on a receiver member having a desired cross-sectional profile includes: moving the receiver member past a plurality of deposition stations, with at least two of the deposition stations having first and second sources of marking particles having different volume average diameters, and selecting at least two different deposition stations with each having different size marking particles and depositing selected amounts of different marking particles on selected different locations of the receiver member depending upon the desired cross-section of a portion of the lens, the unfused toner stack height capability of each deposition station, and the fused toner stack height capability for the fusing method. The method further includes heating the deposited marking particles to fuse the toner stack and form the article having desired cross-sectional profile.

### FIELD OF THE INVENTION

The present invention relates to the making of articles with a desired profile by depositing different size marking particles in selected amounts and locations on a receiver member.

### BACKGROUND OF THE INVENTION

A method of printing optical elements using electrography is set forth in U.S. Pat. No. 7,831,178. Described in this patent is the technique of depositing, in register, one on top of the other, first and second layers of predetermined size marking particles based upon “lens shape determinants” so as to create a final multi-dimensional shape to create a final optical element. This final shape is optionally treated with heat, pressure or chemicals, as during fusing, to give the desired predetermined multi-dimensional shape or shape characteristics. Also described in this patent is an algorithm for determining the height of each toner layer. After each layer is laid down, the height of the layer can be measured and the remaining heights recalculated based on the lens shape determinants information on the toner. A determination is made as to whether a height correction should be made to the remaining layers as they are laid down or if alternate layers should be applied in conjunction with alternate fixing methods, such as a reducing heat fixing step. A problem with U.S. Pat. No. 7,831,178 is that it can require multiple passes for depositing materials of different sizes to produce the lens. Another problem is the lay-down uniformity and the effective flowing together of particles having significantly different mean volume average diameters. Many additional particle-to-particle interfaces are introduced when depositing particles having significantly different mean volume average diameters on top of each other and these interfaces can introduce voids or mismatches in properties that would detract from the lens performance.

### SUMMARY OF THE INVENTION

It has been determined that in order to form lenses with different size marking particles there are considerations that should be taken into account. The present invention deposits the different size marking particles at different locations in accordance with these considerations.

In accordance with the present invention the above problems are solved by a method of making an article on a receiver member having a desired cross-sectional profile, comprising:

a) moving the receiver member past a plurality of deposition stations, with at least two of the deposition stations having first and second sources of marking particles having different volume average diameters,

b) selecting at least two different deposition stations with each having different size marking particles and depositing selected amounts of different marking particles on selected different locations of the receiver member depending upon the desired cross-section of a portion of the lens, the unfused toner stack height capability of each deposition station, and the fused toner stack height capability for the fusing method; and

c) heating the deposited marking particles to fuse the toner stack and form the article having desired cross-sectional profile.

An important advantage of the present invention is that a methodology is provided for determining the lay-down for each of the predetermined size marking particles by having different size marking particles in separate locations on the receiver member that can produce a lens in a single pass with improved optical properties.

### BRIEF DESCRIPTION OF THE DRAWINGS

In the detailed description of the preferred embodiment of the invention presented below, reference is made to the accompanying drawings, in which:

FIG. 1 is a schematic side elevational view, in cross section, of a typical electrographic reproduction apparatus suitable for use with this invention;

FIG. 2 is a schematic side elevational view, in cross section, of the reprographic image-producing portion of the electrographic reproduction apparatus of FIG. 1, on an enlarged scale;

FIG. 3 is a schematic side elevational view, in cross section, of one printing module of the electrographic reproduction apparatus of FIG. 1, on an enlarged scale;

FIG. 4 shows a block diagram of a flow chart used by a processor to select the amount and location for depositing the different marking particles on a receiver member, the processor can be part of the LCU of FIG. 1 or can be separate from it;

FIG. 5a shows a cross-sectional view of a typical lens that can be made in accordance with the present invention; and

FIG. 5b shows a cross-sectional view of different amounts and locations of different marking particles and a cross-sectional view of the lens after fusing the marking particles.

### DETAILED DESCRIPTION OF THE INVENTION

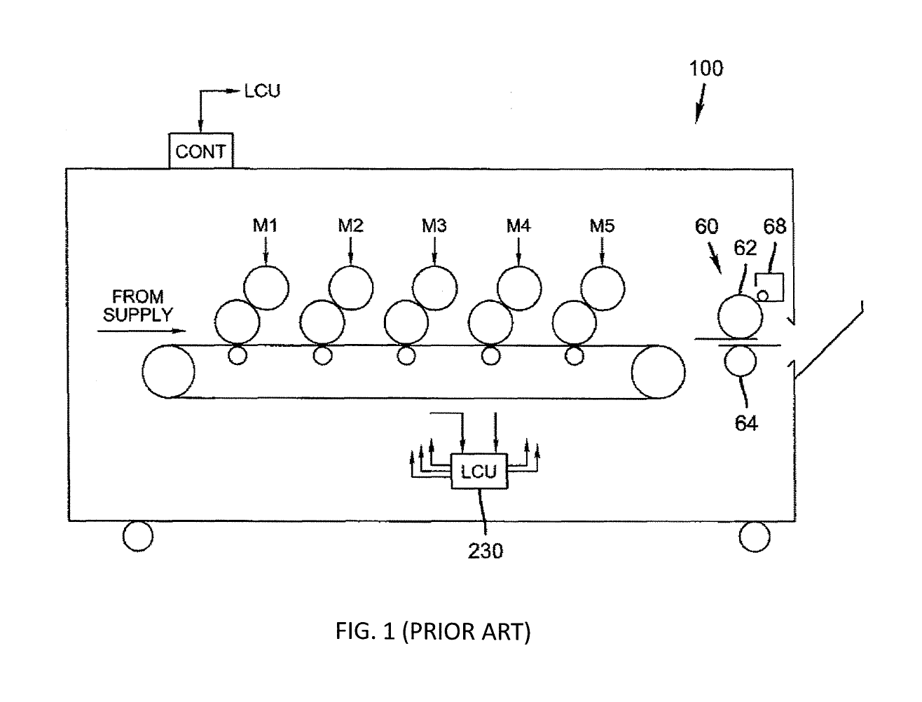

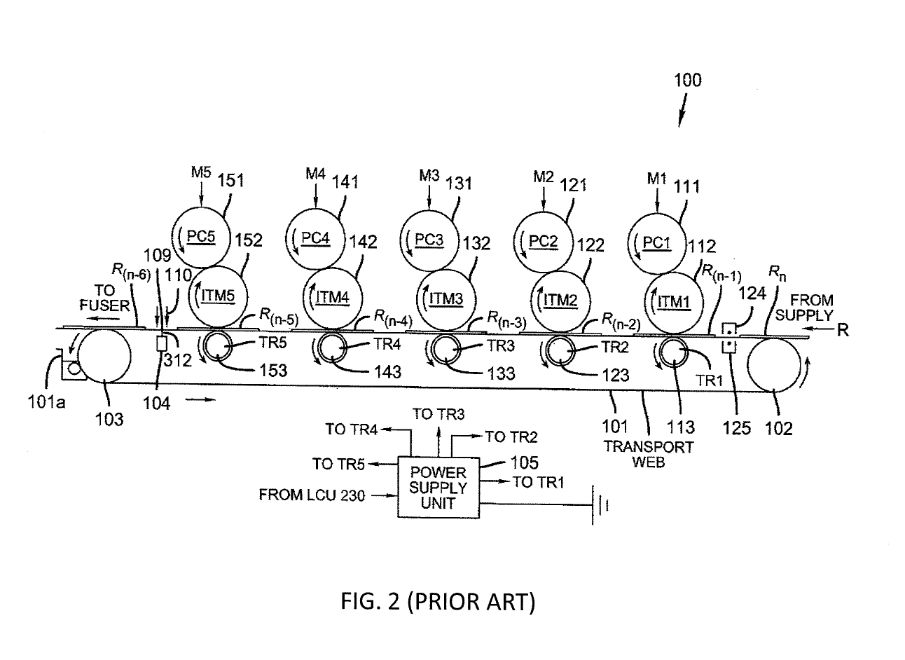

Referring now to the accompanying drawings, FIGS. 1 and 2 are side elevational views schematically showing portions of a typical electrographic print engine or printer apparatus suitable for printing of pentachrome images. Although one embodiment of the invention involves printing using an electrophotographic engine having five sets of single color image producing or printing stations or modules arranged in tandem, the invention contemplates that more or less than five stations can be combined to deposit toner on a single receiver member, or can include other typical electrographic writers or printer apparatus.

An electrographic printer apparatus 100 has a number of tandemly arranged electrostatographic image forming printing modules M1, M2, M3, M4, and M5. Additional modules can be provided. Each of the printing modules M1, M2, M3, M4, and M5 produces a single-color toner image for transfer to a receiver member successively moved through the modules. Each receiver member, during a single pass through the five modules M1-M5, can have transferred in registration thereto up to five single-color toner images to form a pentachrome image. As used herein, the term pentachrome implies that in an image formed on a receiver member, combinations of subsets of the five colors are combined to form other colors on the receiver member at various locations on the receiver member, and that all five colors participate to form process colors in at least some of the subsets wherein each of the five colors can be combined with one or more of the other colors at a particular location on the receiver member to form a color different than the specific color toners combined at that location.

In a particular embodiment, printing module M1 forms black (K) toner color separation images, M2 forms yellow (Y) toner color separation images, M3 forms magenta (M) toner color separation images, and M4 forms cyan (C) toner color separation images. Printing module M5 can form a red, blue, green or other fifth color separation image. It is well known that the four primary colors, cyan, magenta, yellow, and black can be combined in various combinations of subsets thereof to form a representative spectrum of colors and having a respective gamut or range dependent upon the materials used and process used for forming the colors. However, in the electrographic printer apparatus, a fifth color can be added to improve the color gamut. In addition to adding to the color gamut, the fifth color can also be used as a specialty color toner image, such as for making proprietary logos, or a clear toner for image protective purposes.

Receiver members Rₙ-R₍ₙ₋₆₎ (as shown in FIG. 2) are delivered from a paper supply unit (not shown) and transported through the printing modules M1-M5 in a direction indicated in FIG. 2 as R. The receiver members Rₙ-R₍ₙ₋₆₎ are adhered (e.g., preferably electrostatically via coupled corona tack-down chargers 124, 125) to an endless transport web 101 entrained and driven about rollers 102, 103. Each of the printing modules M1-M5 similarly includes a photoconductive imaging roller, an intermediate transfer member roller, and a transfer backup roller. Thus in printing module M1, a black color toner separation image can be created on the photoconductive imaging roller PC1 (111), transferred to intermediate transfer member roller ITM1 (112), and transferred again to a receiver member moving through a transfer station, which transfer station includes ITM1 forming a pressure nip with a transfer backup roller TR1 (113). Similarly, printing modules M2, M3, M4, and M5 include, respectively: PC2, ITM2, TR2 (121, 122, 123); PC3, ITM3, TR3 (131, 132, 133); PC4, ITM4, TR4 (141, 142, 143); and PC5, ITM5, TR5 (151, 152, 153). A receiver member, Rₙ, arriving from the supply, is shown passing over roller 102 for subsequent entry into the transfer station of the first printing module, M1, in which the preceding receiver member R₍ₙ₋₁₎ is shown. Similarly, receiver members R₍ₙ₋₂₎, R₍ₙ₋₃₎, R₍ₙ₋₄₎, and R₍ₙ₋₅₎ are shown moving respectively through the transfer stations of printing modules M2, M3, M4, and M5. An unfused image formed on receiver member R₍ₙ₋₆₎ is moving as shown towards a fuser of any well known construction, such as the fuser assembly 60 (shown in FIG. 1).

A power supply unit 105 provides individual transfer currents to the transfer backup rollers TR1, TR2, TR3, TR4, and TR5 respectively. A logic and control unit 230 (FIG. 1) includes one or more computers and in response to signals from various sensors associated with the electrophotographic printer apparatus 100 provides timing and control signals to the respective components to provide control of the various components and process control parameters of the apparatus in accordance with well understood and known employments. A cleaning station 101a for transport web 101 is also typically provided to permit continued reuse thereof.

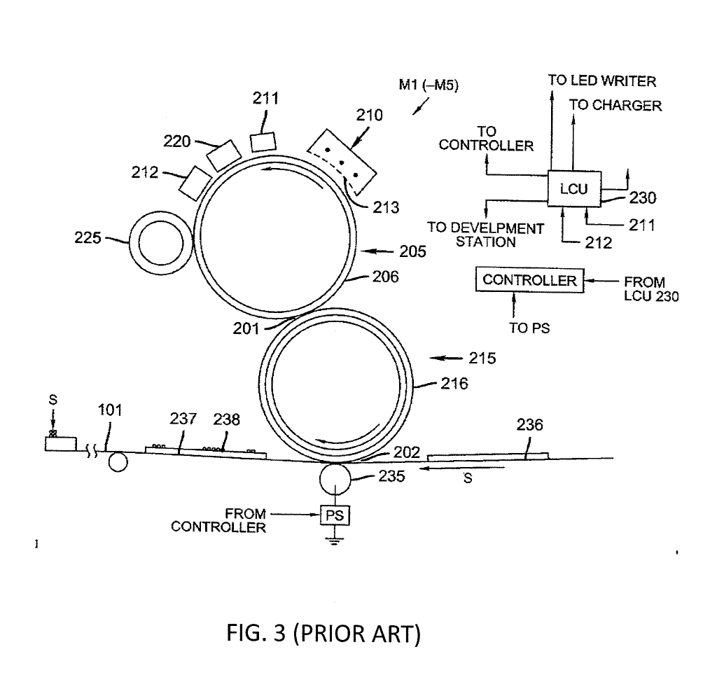

With reference to FIG. 3 wherein a representative printing module (e.g., M1 of M1-M5) is shown, each printing module M1, M2, M3, M4, M5 of the electrographic printer apparatus 100 includes a plurality of electrographic imaging subsystems for producing one or more multilayered image or shape. Included in each printing module M1, M2, M3, M4, M is a primary charging subsystem 210 for uniformly electrostatically charging a surface 206 of a photoconductive imaging member (shown in the form of an imaging cylinder 205). Primary charging subsystem 210 can have a grid 213 for improving the charge deposition uniformity onto surface 206 of a photoconductive imaging member. An exposure subsystem 220 is provided for image-wise modulating the uniform electrostatic charge by exposing the photoconductive imaging member to form a latent electrostatic multi-layer (separation) image of the respective layers. Non-contacting electrostatic voltmeters 211 and 212 are used to measure the surface voltage of a photoconductive imaging member before and after exposure subsystem 220. A development station subsystem 225, serves for developing the image-wise exposed photoconductive imaging member. An intermediate transfer member 215 is provided for transferring the respective layer (separation) image from the photoconductive imaging member through a transfer nip 201 to the surface 216 of the intermediate transfer member 215 and from the intermediate transfer member 215 to a receiver member (receiver member 236 shown prior to entry into the transfer nip 202 and receiver member 237 shown subsequent to transfer of the multilayer (separation) image 238) which receives the respective (separation) images 238 in superposition to form a composite image thereon. Transport web 101 conveys receiver members 236 and 237 and moves at a speed S. Transfer roller 235 is used to press the receiver against intermediate transfer member 215 and is raised to a voltage supplied by a power supply so as to establish an electrostatic transfer field across transfer nip 202.

Subsequent to transfer of the respective (separation) multilayered images 238, overlaid in registration, one from each of the respective printing modules M1-M5, the receiver member 236, 237 is advanced to a fusing assembly across a space 109 (FIG. 2) to optionally fuse the multilayer toner image 238 to the receiver member 236, 237 resulting in a receiver product, also referred to as a print. In the space 109 there can be a sensor 104 and an energy source 110. This can be used in conjunction to a registration reference 312 as well as other references that are used during deposition of each layer of toner, which is laid down relative to one or more registration references 312, such as a registration pattern.

The apparatus of the invention uses a clear, without any pigment, toner in one or more stations. The clear toner differs from the pigmented toner described above. It can have larger particle sizes from that described above. The multilayer (separation) images 238 produced by the apparatus of the invention do not have to be indicia and are shown as made up entirely of clear toner having one or more layers. Alternately the image 238 can be a colored toner and be indicia followed by other layers that include clear or colored toner as will be discussed in more detail later. The layers of clear toner can each have the same or different indices of refraction. Another embodiment would tint or coat some or all of the clear toner in such a way that it acted as a filter. The receiver member 236, 237 can be transparent, translucent or opaque.

Associated with the printing modules M1-M5 is a main printer apparatus logic and control unit (LCU) 230, which receives input signals from the various sensors associated with the electrophotographic printer apparatus 100 and sends control signals to the charging subsystem 210, the exposure subsystem 220 (e.g., LED writers), and the development stations 225 of the printing modules M1-M5. Each printing module M1, M2, M3, M4, M5 can also have its own respective controller coupled to the electrophotographic printer apparatus 100 main LCU 230.

Subsequent to the transfer of the multiple layer toner (separation) images 238 in superposed relationship to each receiver member 236, 237, the receiver member 236, 237 is then serially de-tacked from transport web 101 and sent in a direction to the fusing assembly 60 to fuse or fix the dry toner images to the receiver member 236, 237. This is represented by the five modules (M1-M5) shown in FIG. 2 but can include only one module and preferably anywhere from two to as many as needed to achieve the desired results including the desired final predetermined multidimensional shape. The transport web 101 is then reconditioned for reuse by cleaning and providing charge to both corona tack-down chargers 124, 125 (see FIG. 2) which neutralizes charge on the opposed surfaces of the transport web 101.

The electrostatic image is developed by application of marking particles (toner) to the latent image bearing photoconductive drum by the respective development station subsystem 225. Each of the development stations of the respective printing modules M1-M5 is electrically biased by a suitable respective voltage to develop the respective latent image, which voltage can be supplied by a power supply or by individual power supplies (not illustrated). Preferably, the respective developer is a two-component developer that includes toner marking particles and carrier particles, which can be magnetic. Each development station has a particular layer of toner marking particles associated respectively therewith for that layer. Thus, each of the five modules creates a different layer of the image on the respective photoconductive drum. As will be discussed further below, a pigmented (i.e., color) toner development station can be substituted for one or more of the non-pigmented (i.e., clear) developer stations so as to operate in similar manner to that of the other printing modules, which deposit pigmented toner. The development station of the clear toner printing module has toner particles associated respectively therewith that are similar to the color marking particles of the development stations but without the pigmented material incorporated within the toner binder.

With further reference to FIG. 1, transport belt 101 transports the toner image carrying receiver members Rn-R₍ₙ₋₆₎ to an optional fusing or fixing assembly 60, which fixes the toner particles to the respective receiver members Rn-R₍ₙ₋₆₎ by the application of heat and pressure. More particularly, fusing assembly 60 includes a heated fusing roller 62 and an opposing pressure roller 64 that form a fusing nip there between. Fusing assembly 60 also includes a release fluid application substation generally designated 68 that applies release fluid, such as, for example, silicone oil, to fusing roller 62. The receiver members Rn-R₍ₙ₋₆₎ or prints carrying the fused image are transported seriatim from the fusing assembly 60 along a path to either a remote output tray, or is returned to the image forming apparatus to create an image on the backside of the receiver member (to form a duplex print).

The logic and control unit (LCU) 230 shown in FIG. 3 includes a microprocessor incorporating suitable look-up tables and control software, which is executable by the LCU 230. The control software is preferably stored in memory associated with the LCU 230. Sensors associated with the fusing assembly 60 (FIG. 1) provide appropriate signals to the LCU 230. In response to the sensors 104, the LCU 230 issues command and control signals that adjust the heat and pressure within fusing nip 66 (FIG. 1) and otherwise generally nominalizes and optimizes the operating parameters of fusing assembly 60 (FIG. 1) for imaging substrates.

Image data for writing by the electrophotographic printer apparatus 100 can be processed by a raster image processor (RIP), which can include either a layer or a color separation screen generator or generators. For both a clear and a colored layered image case, the output of the RIP can be stored in frame or line buffers for transmission of the separation print data to each of respective LED writers, for example, K, Y, M, C, and L (which stand for black, yellow, magenta, cyan, and clear respectively, or alternately multiple clear layers L₁, L₂, L₃, L₄, and L₅. The RIP and separation screen generator can be a part of the electrophotographic printer apparatus 100 or remote there from. Image data processed by the RIP can be obtained from a multilayer document scanner such as a color scanner, or a digital camera or produced by a computer or from a memory or network which typically includes image data representing a continuous image that needs to be reprocessed into halftone image data in order to be adequately represented by the printer. The RIP can perform image processing processes including layer corrections, in order to obtain the desired final shape on the final print. Image data is separated into the respective layers, similarly to separate colors, and converted by the RIP to halftone dot image data in the respective color using matrices, which include desired screen angles and screen rulings. The RIP can be a suitably programmed computer and logic devices and is adapted to employ stored or produced matrices and templates for processing separated image data into rendered image data in the form of halftone information suitable for printing.

The toner used to form the final predetermined shape in one embodiment can be a styrenic (styrene butyl acrylate) type or a polyester type toner binder. The typical refractive index of these polymers, when used as toner resins, range from 1.53 to almost 1.60. These are typical refractive index measurements for the polyester toner binders, as well as styrenic (styrene butyl acrylate) toner. Typically the polyesters are around 1.54 and the styrenic resins are 1.59. The conditions under which it was measured (by methods known to those skilled in the art) are at room temperature and about 590 nm. One skilled in the art would understand that other similar materials can also be used. These can include both thermoplastics, such as the polyester types and the styrene acrylate types as well as PVC and polycarbonates, especially in high temperature applications such as projection assemblies. One example is an Eastman Chemical polyester-based resin sheet, Lenstar™, specifically designed for the lenticular market. Also thermosetting plastics can be used, such as the thermosetting polyester beads prepared in a PVA1 stabilized suspension polymerization system from a commercial unsaturated polyester resin at the Israel Institute of Technology.

The toner used to form the final predetermined shape is affected by the size distribution so a closely controlled size and shape is desirable. This can be achieved through the grinding and treating of toner particles to produce various resultants sizes. This is difficult to do for the smaller particular sizes and tighter size distributions since there are a number of fines produced that should be separated out. This results in either undesirable distribution or a very expensive and poorly controlled development process. An alternative is to use a limited coalescence and evaporative limited coalescence techniques that can control the size through stabilizing particles, such as silicon. These particles are referred to as chemically prepared dry ink (CDI) below. Some of these limited coalescence techniques are described in patents pertaining to the preparation of electrostatic toner particles because such techniques typically result in the formation of toner particles having a substantially uniform size and uniform size distribution. Representative limited coalescence processes employed in toner preparation are described in U.S. Pat. Nos. 4,833,060 and 4,965,131, these references are hereby incorporated by reference.

In the limited coalescence techniques described, the judicious selection of toner additives, such as charge control agents and pigments permits control of the surface roughness of toner particles by taking advantage of the aqueous organic inter-phase present. It is important to take into account that any toner additive employed for this purpose that is highly surface active or hydrophilic in nature can also be present at the surface of the toner particles. Particulate and environmental factors that are important to successful results include the toner particle charge/mass ratios (it should not be too low), surface roughness, poor thermal transfer, poor electrostatic transfer, reduced pigment coverage, and environmental effects such as temperature, humidity, chemicals, radiation, and the like that affects the toner or paper. Because of their effects on the size distribution, they should be controlled and kept to a normal operating range to control environmental sensitivity.

This toner also has a tensile modulus (10³ psi) of 150-500, normally 345, a flexural modulus (10³ psi) of 300-500, normally 340, a hardness of M70-M72 (Rockwell), a thermal expansion of 68-70 10⁻⁶/degree Celsius, a specific gravity of 1.2 and a slow, slight yellowing under exposure to light according to J. H. DuBois and F. W. John, eds., in Plastics, 5^{th} edition, Van Norstrand and Reinhold, 1974 (page 522).

In this particular embodiment various attributes make the use of this toner a good toner to use. In any contact fusing, the speed of fusing and resident times and related pressures applied are also important to achieve the particular final desired shape. Contact fusing may be necessary if faster turnarounds are needed. Various finishing methods would include both contact and non-contact including, heat, pressure, chemical as well as IR and UV. The described toner normally has a melting range that can be between 50-300 degrees Celsius. Surface tension, roughness and viscosity should be such as to yield a spherical not circular shape to better transfer. Surface profiles and roughness can be measured using the Federal 5000 “Surf Analyzer’ and is measured in regular unites, such as microns. Toner particle size, as discussed above is also important since larger particles not only result in the desired heights and shapes but also results in a clearer shape since there is less air inclusions, normally, in a larger particle. Color density is measured under the standard CIE test by Gretag-Macbeth in colorimeter and is expressed in L*a*b* units as is well known. Toner viscosity is measured by a Mooney viscometer, a meter that measures viscosity, and the higher viscosities will keep a shape better and can result in greater height. The higher viscosity toner will also result in a retained form over a longer period of time.

Melting point is often not as important of a measure as the glass transition temperature (Tg), discussed above. This range is around 50-100 degrees Celsius, often around 60 degrees Celsius. Permanence of the color and clear under UV and IR exposure can be determined as a loss of clarity over time. The lower the loss, the better the result. Clarity, or low haze, is important for optical elements that are transmissive or reflective wherein clarity is an indicator and haze is a measure of higher percent of transmitted light.

The unfused toner stack height capability (SUᵢ) for each deposition station i containing a particular mean volume average diameter marking particle is known and defined by SUᵢ=fᵢ(α₁, α₂, α₃, . . . αₙ) where αₙ represents either a parameter of the specific marking particle in deposition station i such as mean volume average diameter or a parameter of deposition station i such as toning potential, representing the potential driving the particle to an imaging or image receiving member. Other particle parameters of interest can include charge-to-mass, packing fraction, shape and size distribution, density, clarity, and refractive index. Other deposition station parameters of interest can include toning field, toning roller rotational speed, toner-photoreceptor spacing, and toner concentration in a two component developer mix.

A minimum and maximum unfused toner stack height (SUminᵢ and SUmaxᵢ) can be defined for each deposition station i: SUminᵢ equals the particular mean volume average diameter in deposition station i and SUmaxᵢ is determined electrostatically by the space charge limit in the development zone of deposition station i. Typically 2SUminᵢ≦SUmaxᵢ≦3SUminᵢ and is highly dependent upon the charge-to-mass of the marking particle. The maximum unfused stack height varies inversely with charge-to-mass, however dusting and contamination will also vary inversely with charge-to-mass.

The fused toner stack height (SFᵢ) for a given unfused stack height (SUᵢ) produced by each deposition station i when using a particular fusing method is SFᵢ=g(SUᵢ, β₁, β₂, β₃, . . . βₘ) where βₘ represents either a parameter of the specific marking particle such as viscoelastic response or a parameter of the particular fusing method such as fuser roller surface temperature for a nipped heated rollers. Other particle parameters of interest include mean volume average diameter, shape and size distribution, surface addenda, melting point, and surface tension. Other fusing method parameters of interest include residence time in fuser, pressure, roller surface finish, and thermal conductivity. Note that depending upon the particular fusing method chosen, SFᵢ can be controllable on a pixel basis, as for example, as in a laser sintering operation.

A minimum and maximum fused toner stack height (SFminᵢ and SFmaxᵢ) can be defined for each deposition station i and correspond to the effect of passing the minimum and maximum unfused toner stack heights (SUminᵢ and SUmaxᵢ) through the fusing station, namely SFminᵢ=g(SUminᵢ, β₁, β₂, β₃, . . . βₘ) and SFmaxᵢ=g(SUmaxᵢ, β₁, β₂, β₃, . . . βₘ).

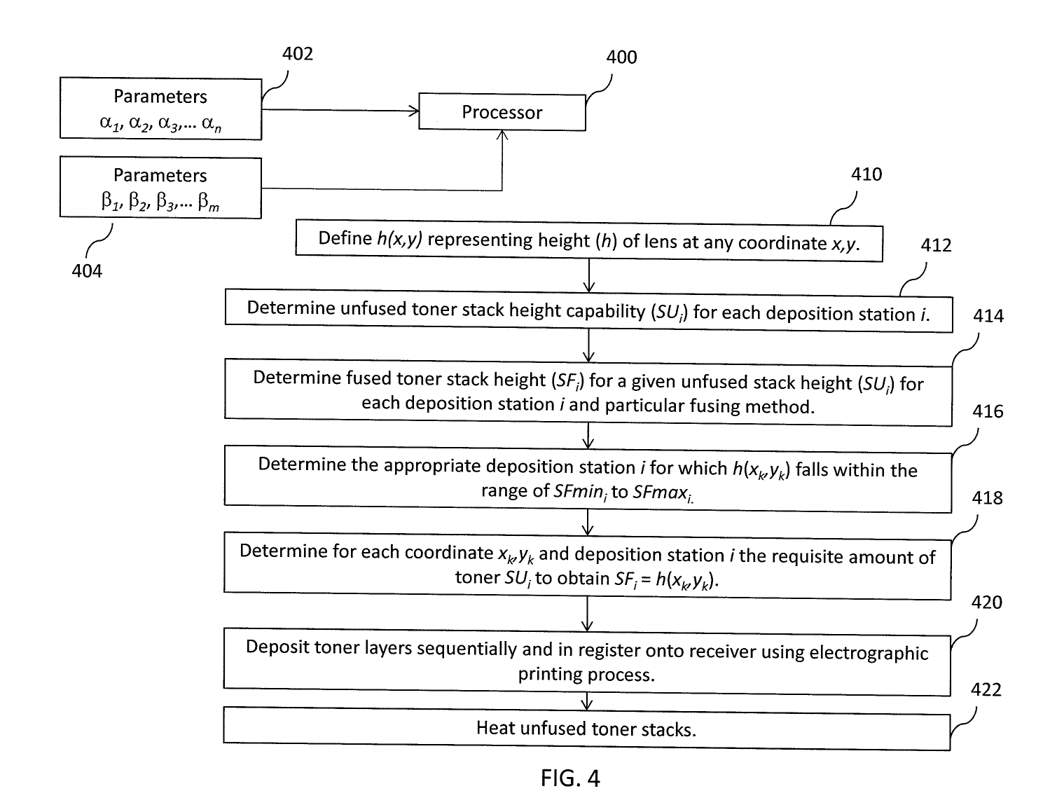

The following algorithm, as shown in FIG. 4, is used to determine the different amounts and locations of different marking particles to be deposited on a substrate in a single pass so as to reproduce the three dimensional lens shape. A processor 400, which can be included in LCU 230 of FIG. 1 or can be separate from it, has input parameter list 402 (α₁, α₂, α₃, . . . αₙ) to aid in determining unfused toner stack height SUᵢ and parameter list 404 (β₁, β₂, β₃, . . . βₘ) to aid in determining fused toner stack height SFᵢ. Processor 400 also contains the following algorithm for producing a lens in accordance with the present invention. The algorithm proceeds in a manner such that the processor computes the amount and location of the different marking particles to be deposited on the receiver member 236, 237 and actuates the deposition stations to deposit the different marking particles onto the receiver member 236, 237. Although a lens is shown in the present invention, it will be understood that other articles can also be made in accordance with this invention.

The algorithm includes a first step 410 to define a function h(x,y) representing the height (h) of the lens at any coordinate x,y for a desired lens profile. In a second step 414, a determination is made for the unfused toner stack height capability (SUᵢ) for each deposition station i using processor 400 and parameter list 402. As a third step 414, a determination is made for the fused toner stack height (SFᵢ) for a given unfused stack height (SUᵢ) for each deposition station i and particular fusing method using processor 400 and parameter list 404. Each deposition station i, including the effects of the fusing step, can provide a range of fused toner stack heights from SFminᵢ to SFmaxᵢ. In a fourth step 416, for each coordinate xₖ,yₖ, processor 400 determines the appropriate deposition station i for which h(xₖ,yₖ) falls within the range of SFminᵢ to SFmaxᵢ. In a fifth step 418, a determination is made for each particular coordinate xₖ,yₖ and deposition station i the requisite amount of toner SUᵢ to obtain SFᵢ=h(xₖ,yₖ), where SUᵢ is varied for a given deposition station i by controlling the toning field and other electrographic process parameters. In a sixth step 420, the electrographic printing apparatus 100 (see FIG. 1) the toner layers are deposited sequentially and in register onto the receiver Rₙ (FIG. 2). Finally, in a seventh step 422 the unfused toner stacks are heated using fusing assembly 60 of electrographic printing apparatus 100, melting and flowing into the desired lens profile while simultaneously being adhered to the receiver.

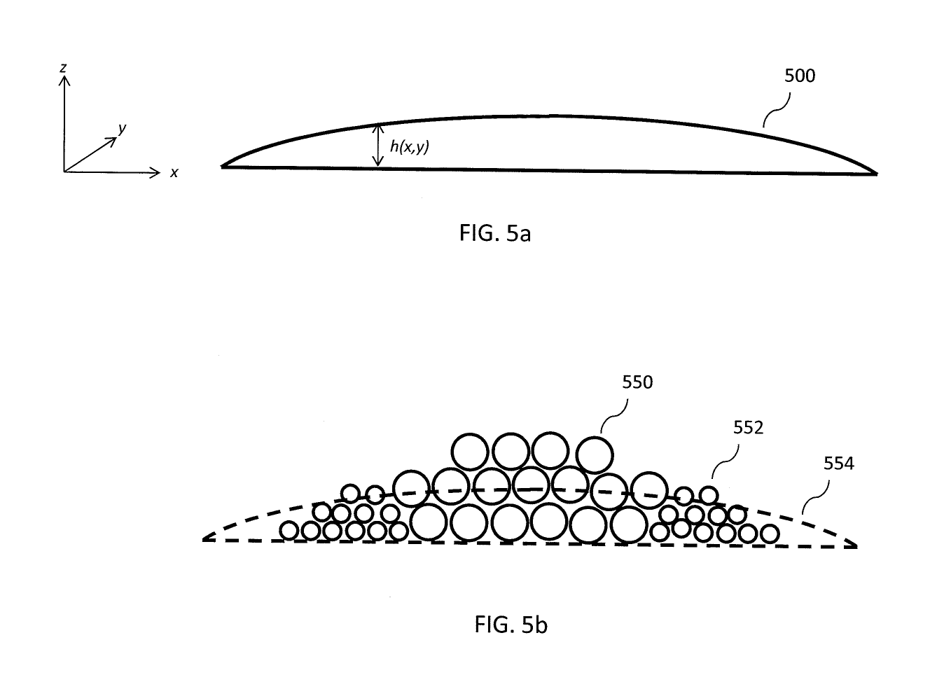

Shown in FIG. 5a is cross-sectional view 500 of a typical lens that can be printed according to the present invention. This results in the deposition pattern of FIG. 5b where a first deposition station is used to deposit marking particles 552 in a first location in the form of a ring in the outer (lower height) regions of the lens whereas a second deposition station is used to deposit marking particles 550 in a second location in the form of a disk in the inner (greater height) region of the lens. Note that marking particles 552 are smaller than marking particles 550, representing the desired mean average volume diameter difference in size of marking particles contained in deposition stations. FIG. 5b also shows cross-sectional view 554 overlaid on the unfused toner stacks representation. Cross-sectional view 554 represents the final lens profile after unfused marking particles 550 and 552 have been fused, displaying the flattening and spreading behavior of melted toner particles. The deposited marking particles 552 and 554 can be selected of different materials so as to have different refractive indices in their corresponding portions of the lens. These refractive indices are selected to provide the desired imaging properties of the lens. As described above, the marking particles are but, depending upon the application, they can be pigmented or dyed particles. The lens produced by the FIG. 5b arrangement will have reduced voids thereby improving the imaging quality of the lens.

In an analytic example not reduced to practice, three deposition stations are provided, each containing a different mean volume average diameter particle. Based upon this diameter and other particle and deposition station parameters, each deposition station has the capability of providing a minimum and maximum unfused stack height ranging from the diameter to two-and-one-half times the diameter. The fusing method results in a fused toner stack height that is roughly one-half of the unfused toner stack height. This yields a minimum and maximum fused stack height ranging from one-half the diameter to one-and-one-quarter times the diameter. TABLE 1 tabulates these values for the toner set having a mean volume average diameter of 8, 20, and 50 micrometer. For a lens that varies in height profile from 4 to 50 micrometers, the processor will use deposition station 1 to apply toner in any region of the lens for which the height falls in the range of 4 to 10 micrometers, varying the toning potential to achieve the desired height within that range. Similarly, the processor will use deposition station 2 to apply toner in any region of the lens for which the height falls in the range of 11 to 25 micrometers and deposition station 3 to apply toner in any region of the lens for which the height falls in the range of 26 to 50 micrometers. In this manner, the lens is formed using only similarly sized particles for a given region.

TABLE 1

| | Mean | Minimum | Maximum | Minimum | Maximum |
|---|---|---|---|---|---|
| | Volume | Unfused | Unfused | Fused | Fused |
| | Average | Stack | Stack | Stack | Stack |
| Deposition | Diameter | Height | Height | Height | Height |
| Station | (μm) | (μm) | (μm) | (μm) | (μm) |
| 1 | 8 | 8 | 20 | 4 | 10 |
| 2 | 20 | 20 | 50 | 10 | 25 |
| 3 | 50 | 50 | 125 | 25 | 62.5 |

It can be realized that if finer resolution is required for heights less than 4 micrometers, another deposition station containing particles having a 3 micrometer mean volume average diameter can be used. This deposition station would enable fused stack heights ranging from 1.5 to 3.75 micrometers.

The invention has been described in detail with particular reference to certain preferred embodiments thereof, but it will be understood that variations and modifications can be effected within the spirit and scope of the invention.

### PARTS LIST

60 fuser assembly
62 fusing roller
64 pressure roller
68 release fluid application substation
69 output tray
100 electrophotographic printer assembly
101 transport web
101a cleaning station
102 roller
103 roller
104 sensor
105 power supply unit
109 space
110 energy source
111, 121, 131, 141, 151 imaging roller
112, 122, 132, 142, 152 transfer member roller
113, 123, 133, 143, 153 transfer backup roller
124 corona tack-down chargers
125 corona tack-down chargers
201 transfer nip
202 transfer nip
200 printing modules
205 imaging cylinder
206 surface
210 charging subsystem
211 non-contacting electrostatic voltmeter
212 non-contacting electrostatic voltmeter
213 grid
215 intermediate transfer member
216 surface

### PARTS LIST

### Continued

220 exposure subsystem
225 development station subsystem
230 logic and control unit (LCU)
235 transfer roller
236 receiver member
237 receiver member
238 images
312 registration reference
400 processor
402 input parameter list
404 parameter list
410 first step—define height of lens
412 second step—determine unfused toner stack height capability
414 third step—determine fuser toner stack height
416 fourth step—determine appropriate deposition station
418 fifth step—determine requisite amount of toner
420 sixth step—deposit toner layers and register onto receiver
422 seventh step—heat unfused toner stacks
500 cross sectional view of typical lens
550 marking particles
552 marking particles
554 cross sectional view representing final lens profile
ITM1-ITM5 intermediate transfer member
PC1-PC5 photoconductive imaging roller
Rₙ-R₍ₙ₋₆₎ receiver members
S speed
TR1-TR5 transfer backup roller

1. A method of making an article on a receiver member having a desired cross-sectional profile, comprising:
a) moving the receiver member past a plurality of deposition stations, with at least two of the deposition stations having first and second sources of marking particles having different volume average diameters,
b) selecting at least two different deposition stations with each having different size marking particles and depositing selected amounts of different marking particles on selected different locations of the receiver member depending upon a desired cross-section of a portion of the lens, an unfused toner stack height capability of each deposition station, and a fused toner stack height capability for the fusing method; and
c) heating the deposited marking particles to fuse the toner stack and form the article having desired cross-sectional profile.

2. The method of making a lens on a receiver member having a desired cross-sectional profile, comprising:
a) moving the receiver member past a plurality of deposition stations, with at least two of the deposition stations having first and second sources of marking particles having different volume average diameters,
b) selecting at least two different deposition stations with each having different size marking particles and depositing selected amounts of different marking particles on selected different locations of the receiver member depending upon a desired cross-section of a portion of the lens, an unfused toner stack height capability of each deposition station, and a fused toner stack height capability for the fusing method; and
c) heating the deposited marking particles to fuse the toner stack and form a lens having desired cross-sectional profile.

3. The method according to claim 2, wherein the first source of marking particles has a volume average diameter of twice the size of the second source marking particle volume average diameter.

4. The method according to claim 3, wherein the marking particles are toner particles.

5. The method according to claim 4, wherein the marking particles are non-pigmented and the receiver member is transparent.

6. The method according to claim 2, further including providing a processor that computes the amount and location of the different marking particles to be deposited on the receiver member and actuates the deposition stations to deposit the different marking particles onto the receiver member.

7. The method according to claim 1, wherein the first and second marking particles are selected to produce lens portions with different refractive indices.

8. The method according to claim 1, wherein the marking particles can be pigmented or dyed.
